(19) United States
(12) Patent Application Publication
(10) Pub. No.: US 2020/0160306 A1
(43) Pub. Date: May 21, 2020

(54) Systems and Methods for Payment Transaction Coding and Management

(71) Applicant: The Work Shop Limited, Hamilton (NZ)

(72) Inventor: Melissa Linda Gollan, Hamilton (NZ)

(21) Appl. No.: 16/626,664

(22) PCT Filed: Jun. 27, 2018
(86) PCT No.: PCT/NZ2018/050090

§ 371 Date: Dec. 26, 2019

(30) Foreign Application Priority Data
Jun. 27, 2017 (NZ) 733267

(51) Int. Cl. G06Q 20/20; G06Q 40/00; G06Q 30/04; G06Q 20/40; G06Q 40/02; G06Q 20/10

(52) U.S. Cl. CPC G06Q 20/204; G06Q 20/206; G06Q 40/12; G06Q 30/04; G06Q 20/102; G06Q 40/10; G06Q 40/02; G06Q 20/108; G06Q 20/4014

(57) ABSTRACT

A merchant computing system and a transaction processing computing system are disclosed. The merchant computing system produces a transaction data packet containing transaction data relating to the purchase of goods or services. The merchant computing system configured to receive a purchasing entity identified and user supplied transaction identifier for inclusion in the transaction data packet. The transaction processing computer system receives the transaction data packet from the merchant computing system.

### STATEMENT OF CORRESPONDING APPLICATIONS

This application is based on the provisional specification filed in relation to New Zealand Patent Application No. 733267, the entire contents of which are incorporated herein by reference.

### TECHNICAL FIELD

Embodiments of the disclosure relate to systems and methods for coding payment transactions and subsequent processing for accounting and compliance purposes.

### BACKGROUND

Numerous business management software services exist, purporting to reduce the time burden on businesses with regard to accounting and financial management practices.

However, there remain aspects which are highly labour intensive or reliant on individuals retaining and correctly lodging documentation. In particular, expense management and invoice reconciliation hinge on the point of sale and issuance of invoices.

Typically, the purchaser must retain a merchant produced receipt for proof of purchase, product or service information, and tax details. A physical copy of the receipt is generally kept by the purchaser until being coded by the purchaser and reconciled in chronological order to the relevant statement, then submitted for scrutiny and tax purposes to their manager or business accounts person, who then passes this to the business accountant for annual returns processing. While electronic data relating to the transaction is produced by the merchant's point of sale systems, particularly for processing payment with the payment provider (for example a banking institution), this data is typically constrained to minimal characteristics of the transaction and does not include information essential to typical bookkeeping processes such as line item details (both product/service and cost), and tax components. The coding and allocation aspect is also often reliant on the recollection of the purchaser some time after the fact, potentially introducing inaccuracies and requiring reference to other sources of information to corroborate the purchaser's recollection.

The situation becomes further complicated when processing end of month statements for payment approval, where individual invoices within a statement may include multiple line items relating to different client accounts. Price checking and reconciliation of each line item can be a labour intensive task, especially for larger enterprises, and potentially introduce delays in payment approval being given while discrepancies are identified and remedied.

It is an object of the present invention to address at least one of the foregoing problems or at least to provide the public with a useful choice.

Further aspects and advantages of the present invention will become apparent from the ensuing description which is given by way of example only.

### SUMMARY

According to an aspect of the present disclosure there is provided a system including:
a merchant computing system including: at least one processor; and a computer readable storage medium having computer readable program code embodied therewith and executable by the at least one processor, the computer readable program code including:
   computer readable program code that produces a transaction data packet containing transaction data relating to the purchase of goods or services, wherein the merchant computing system is configured to receive a purchasing entity identifier and user supplied transaction identifier for inclusion in the transaction data packet;
a transaction processing computing system including: at least one processor; and a computer readable storage medium having computer readable program code embodied therewith and executable by the at least one processor, the computer readable program code including:
   computer readable program code that receives the transaction data packet from the merchant computing system.

According to an aspect of the present disclosure there is provided a method, the method including: utilizing at least one processor to execute computer code that performs the steps of:
producing, at a merchant computing system, a transaction data packet containing transaction data relating to the purchase of goods or services, wherein the transaction data packet includes a purchasing entity identifier and user supplied transaction identifier received by the merchant computing system;
transmitting the transaction data packet to a transaction processing computing system.

The merchant computing system may be any suitable means by which purchase of goods and services from a merchant may be effected and recorded. It should be appreciated that the merchant computing system may include may operate client based, remote, or distributed software to implement the functionality described herein. In exemplary embodiments, the merchant computing system may include a point of sale device for interaction with a user's payment means to carry out the transaction. It is envisaged that the transaction data packet discussed herein will typically be distinct to the communication between the merchant computing system and a financial institution (for example a banking institution) to effect an electronic funds transfer authorised by a user—for example via use of a payment card at a point of sale—although in exemplary embodiments the transaction data packet may be reconciled with said data transmitted to the financial institution. It is envisaged that this may enable the provision of richer data from the merchant computing system to the user, as electronic funds transfer communications with financial institutions are typically very prescriptive and exclude the potential for merchant transaction information relevant to the user for accounting purposes (for example the amount charged without tax, the tax component, a description of the goods and/or services supplied, or the quantity or volume of supply).

The purchasing entity identifier may be any suitable means by which the individual or enterprise accessing the services of the transaction processing computing system may be identified on receipt of the transaction data packet, for example an account identifier. In an exemplary embodiment the purchasing entity identifier may identify an individual in addition to an enterprise with which they are associated—for example an employee of a company. The purchasing entity identifier may be provided to the merchant computing system by a number of means, for example: manual entry, scanning of an identification device (for example, a card carrying a barcode, or an RFID or NFC tag), or via the device by which payment is effected (for example, a payment card or user device operating a payment service such as Apple Pay™).

The user supplied transaction identifier may be any suitable means by which the associated transaction data may be distinguished from other transaction data received for the purchasing entity at the transaction processing computing system. For example, the transaction identifier may be a series of alphanumeric characters. It is envisaged that the user supplied transaction identifier may be user specific accounting information, for example a predefined code allocated to a specific activity such as a general ledger code or a job number.

In an exemplary embodiment a purchase justification may be provided at the merchant computing system and entered with the transaction information. For example, the purchase justification may include alphanumeric characters. It is envisaged that the purchase justification may be used to provide further detail regarding the nature of the transaction for the user's reference purposes, such as a description of the nature or content of the transaction.

In exemplary embodiments in which a transaction includes a plurality of line items, a user supplied transaction identifier, and purchase justification where applicable, may be provided for one of: each line item, subsets of line items, and an entire set of line items.

In an exemplary embodiment the user supplied transaction identifier, and purchase justification where applicable, may be entered into the merchant computing system by the merchant. For example, the user may advise the merchant of these particulars at the point of sale.

In an exemplary embodiment the user supplied transaction identifier, and purchase justification where applicable, may be provided to the merchant computing system via a user device. For example, the user device may be a mobile communication device. In one exemplary embodiment the user device may interact directly with the merchant computing system to prompt a user to enter the user supplied transaction identifier and purchase justification into the user device for transmission to the merchant computing system. In one exemplary embodiment the user device may interact with the merchant computing system via the transaction processing computing system, transmitting the user supplied transaction identifier and purchase justification from the user device to the transaction processing computing system for subsequent transmission to the merchant computing system.

It is envisaged that inclusion of the user supplied transaction identifier in the transaction data packet by the merchant computing system may assist with reducing fraudulent behaviour through subsequent manipulation of financial records. However, it should be appreciated that in aspects of the present disclosure the transaction data packet may be transmitted separately to the user supplied transaction identifier. For example, the merchant computing system may transmit the transaction data packet without the user supplied transaction identifier, on receipt of which the transaction processing computing system may request the user supplied transaction identifier from an associated user for recordal against the transaction data.

The transaction processing computing system may be configured to perform a range of functions using the user supplied transaction identifier. It is envisaged that the transaction processing computing system may be operated as software as a service (SaaS), although it should be appreciated that the transaction processing computing system may operate client based, remote, or distributed software to implement the functionality described herein. It should further be appreciated that while it is envisaged that the transaction processing computing system may operate as a distinct entity to systems of a financial institution providing payment services, and will be described as such herein, in an exemplary embodiment the transaction processing computing system may form part of the systems of such a financial institution.

In an exemplary embodiment the transaction processing computing system may provide a user interface by which a user may access and review all accounting information associated with received transaction data packet, and gain access to actions provided by the transaction processing computing system.

In an exemplary embodiment the transaction processing computing system may provide a payment interface, for example for the payment of invoices, expense reimbursement, or payment of tax. The payment interface may, for example, act as a payment portal via one or more payment gateways as known in the art.

In an exemplary embodiment the transaction may relate to an expense incurred by an individual which is eligible for reimbursement. The transaction processing computing system may be configured to identify a transaction associated with a transaction data packet as being eligible for reimbursement based at least in part on the user supplied transaction identifier. In an exemplary embodiment the individual's preferred account for reimbursement may be associated with the purchasing entity identifier included in the transaction data packet, and automatically populate the payment interface. Alternatively, approval of the reimbursement may result in communication with an accounting software service managing the enterprises payroll to approve addition of the reimbursement to the next scheduled payment of wages or salary.

In an exemplary embodiment the transaction may relate to a purchase on account. The transaction processing computing system may be configured to identify purchases which have yet to be paid, permit review of accounting information relating to the transaction, and facilitate payment thereof via the payment interface.

In an exemplary embodiment the transaction processing computing system may be configured to receive a merchant's end of month statement, for example output by the merchant computing system. In an exemplary embodiment the transaction processing computing system may be configured to reconcile invoices from received transaction data packets with the received end of month statement. In an exemplary embodiment the transaction processing computing system may be configured to identify discrepancies between the statement and information associated with the individual invoices.

In an exemplary embodiment the transaction processing computing system may be configured to determine a tax component associated with a transaction recorded with the transaction processing computing system. The tax component may be that owing to a government, or one which may be claimed. By way of example, a Goods and Services Tax (GST) component of transactions received from merchants may be identified. The eligibility of this GST to be claimed may be determined, at least in part, using the user supplied transaction identifier. Similarly, invoices issued via the transaction processing computing system may include a GST component, and the system may identify this as being owing. As a further example, the user supplied transaction identifier may be used to determine whether a transaction requires payment of Fringe Benefit Tax (FBT).

In an exemplary embodiment the transaction processing computing system may be configured to communicate with a taxation agency. For example, the transaction processing computing system may populate requisite forms for submission to the taxation agency, or interact with systems thereof to complete a digital equivalent. In an exemplary embodiment the transaction processing computing system may advise of tax payments, and facilitate payment via the payment interface. In an exemplary embodiment the transaction processing computing system may advise of tax claims.

In an exemplary embodiment the system may be configured to produce a customer consolidated invoice, including transaction data from a plurality of transactions relating to a customer. It is envisaged that the system may populate a customer consolidated invoice template with merchant invoice data or line item data associated with a selected user supplied transaction identifier (for example a code, or job number).

In an exemplary embodiment the system may be configured to produce a merchant consolidated invoice, including transaction data from a plurality of transactions from related merchants. For example, invoices from a franchised supply company with a plurality of merchant stores may be consolidated for a large enterprise customer based on an associated purchasing entity identifier.

In an exemplary embodiment the transaction processing computing system may be configured to compare data associated with received transaction data packets against at least one purchase order issued to the merchant(s) from which the transaction data packets are received. In an exemplary embodiment the at least one purchase order may be issued via the transaction processing computing system, including at least one user supplied transaction identifier, and at least one purchase justification where applicable. Such a comparison may be used to identify discrepancies, for example in the items or quantity thereof or price.

In an exemplary embodiment the system may be configured to interface with sources of data. By way of example, such data sources may include regulatory, tax, levy, statistical and business information (from various sources including local and central government).

In an exemplary embodiment the system may include an application programming interface (API) module configured to manage interfacing with external services, for example accounting systems, payment services, merchant systems, taxation agency systems, and data sources. The API module may manage the respective authentication, authorisation, and encryption protocols required for the system to interface with the respective APIs of the services.

The above and other features will become apparent from the following description, taken in conjunction with the accompanying drawings.

### BRIEF DESCRIPTION OF DRAWINGS

Further aspects of the present invention will become apparent from the following description which is given by way of example only and with reference to the accompanying drawings in which:

FIG. 1 is a schematic diagram of an exemplary networked system for a transaction processing service in accordance with an embodiment of the present disclosure;

FIG. 2 is a block diagram of an exemplary transaction processing service;

FIG. 3 is a flow diagram of an exemplary method of producing a transaction data packet to be performed within the system;

FIG. 4 is an exemplary merchant user interface;

FIG. 5 is an exemplary transaction processing user interface;

FIGS. 6A and 6B illustrate an exemplary customer invoice generation user interface;

FIG. 7 is a flow diagram of an exemplary method of reimbursing incurred expenses;

FIG. 8 is a flow diagram of an exemplary method of reconciling an end of month statement against received transactions;

FIG. 9 is a flow diagram of an exemplary method of processing tax components of transactions with the transaction processing service.

### DETAILED DESCRIPTION

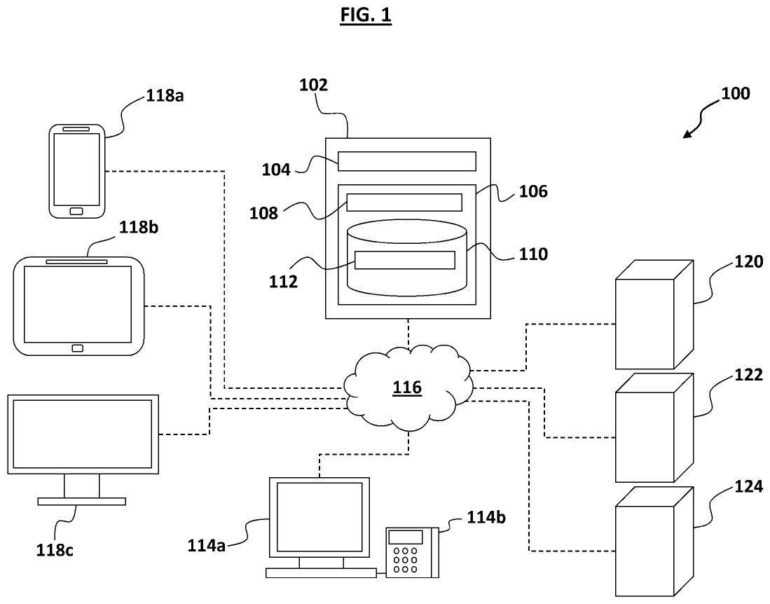

FIG. 1 presents a schematic diagram of a system 100 depicting various computing devices that can be used alone or together in accordance with exemplary embodiments of the disclosure. The system 100 includes a transaction processing service 102, illustrated in this exemplary embodiment as being implemented in a server—for example one or more dedicated server devices, or a cloud based server.

By way of example, the cloud server of the transaction processing service 102 may have processing facilities represented by a processor 104, memory 106, and other components typically present in such computing environments. In the exemplary embodiment illustrated the memory 106 stores information accessible by processor 104, the information including instructions 108 that may be executed by the processor 104 and data 110 that may be retrieved, manipulated or stored by the processor 104. The memory 106 may be of any suitable means known in the art, capable of storing information in a manner accessible by the processor, including a computer-readable medium, or other medium that stores data that may be read with the aid of an electronic device. The processor 104 may be any suitable device known to a person skilled in the art. Although the processor 104 and memory 106 are illustrated as being within a single unit, it should be appreciated that this is not intended to be limiting, and that the functionality of each as herein described may be performed by multiple processors and memories, that may or may not be remote from each other.

The instructions 108 may include any set of instructions suitable for execution by the processor 104. For example, the instructions 108 may be stored as computer code on the computer-readable medium. The instructions may be stored in any suitable computer language or format. Data 110 may be retrieved, stored or modified by processor 104 in accordance with the instructions 108. The data 110 may also be formatted in any suitable computer readable format. Again, while the data is illustrated as being contained at a single location, it should be appreciated that this is not intended to be limiting—the data may be stored in multiple memories or locations. The data 110 stored on server may include databases 112.

The transaction processing service 102 may communicate with a merchant computing system 114a having point of sale payment facilitation services 114b, via a network 116 potentially comprising various configurations and protocols including the Internet, intranets, virtual private networks, wide area networks, local networks, private networks using communication protocols proprietary to one or more companies—whether wired or wireless, or a combination thereof.

The transaction processing service 102 may communicate with user devices via the network 116, for example smartphone 118a, tablet computer 118b, or personal computer 118c to provide access to functionality and data of the transaction processing service 102.

The transaction processing service 102 may further communicate, for example, with financial institution services 120 in order to access payment services and financial records. The transaction processing service 102 may further communicate, for example, with accounting software services 122 in order to record data relating to transactions received and processed by the transaction processing service 102. The transaction processing service 102 may further communicate, for example, with tax agency services 124 in order to facilitate payment, and requests for return, of tax.

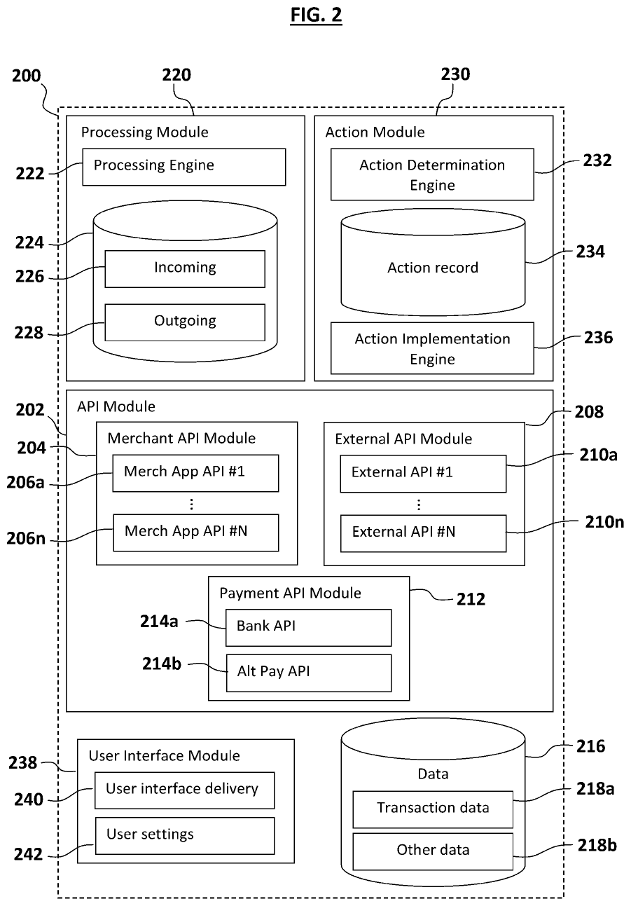

FIG. 2 illustrates an exemplary structure 200 of the transaction processing service 102. The service 102 includes an application programming interface (API) module 202 configured to manage interfacing with the other services and devices within the system 100. A merchant API module 204 manages interfacing with merchant point of sale and accounting services via merchant APIs 206a to 206n. An external resource API module 208 manages interfacing with other external resources via external resource APIs 210a to 210n to obtain and deliver data and access functionality of the external resource—for example the financial institution services 120, accounting software services 122, and tax agency services 124.

A payment API module 212 manages interfacing with payment services, for example via bank API 214a or an alternate payment service API 214b.

Data 216 stored, or accessed by, the transaction processing service 102 may include transaction data 218a, and non-transaction specific data 218b.

The transaction processing service 102 includes a processing module 220 configured to process the data 216. The processing module 220 includes a processing engine 222 implementing rules and algorithms to the data 216. The processing engine 222 may reference a library 224 of algorithms, including for example incoming transaction algorithms 226, and outgoing transaction algorithms 228.

The transaction processing service 102 includes an action module 230 configured to manage the identification and implementation of actions in the system 100. An action determination engine 232 may reference a record 234 of potential actions—whether available via transaction processing service 102, or via interfacing with external resources. The action module 230 includes an action implementation engine 236 configured to manage implementation of the actions determined to be available—whether automatically based on predetermined user criteria, or on authorisation by the user as will be described further below.

The transaction processing service 102 includes a user interface module 238 for delivery of an user interface by which a user may access data and functionality of the transaction processing service 102. For example, the user interface may be a graphical user interface displayed on a user device. The user interface module 238 may include a user interface delivery engine 240—for example connecting to a locally installed application or web browser on the user device—and a record 242 of user settings or preferences (whether user initiated or determined by monitoring user activity).

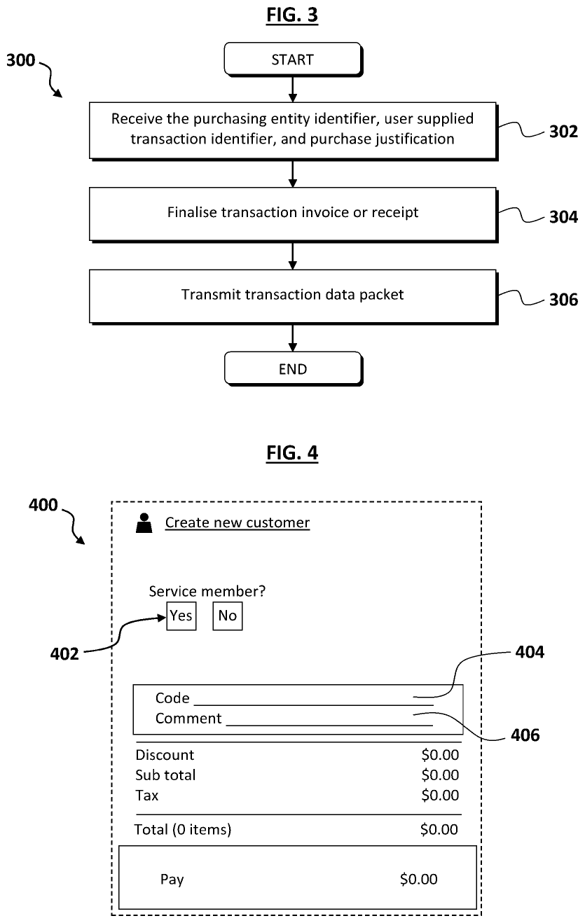

FIG. 3 shows an exemplary method 300 to be performed within the system 100. In a first step, the merchant computing system 114a receives the purchasing entity identifier, user supplied transaction identifier, and a purchase justification for a transaction. Referring to FIG. 4, a merchant user interface (UI) 400 includes a service membership login option 402, selection of which enables entry of a purchasing entity identifier. The merchant UI 400 also includes a user supplied transaction identifier field 404 and purchase justification field 406. A user supplied transaction identifier and purchase justification may be entered for each line item in the invoice/receipt to be issued. In step 304 the merchant computing system 114a finalizes the invoice, and in step 306 transmits the transaction data packet to the transaction processing service 102.

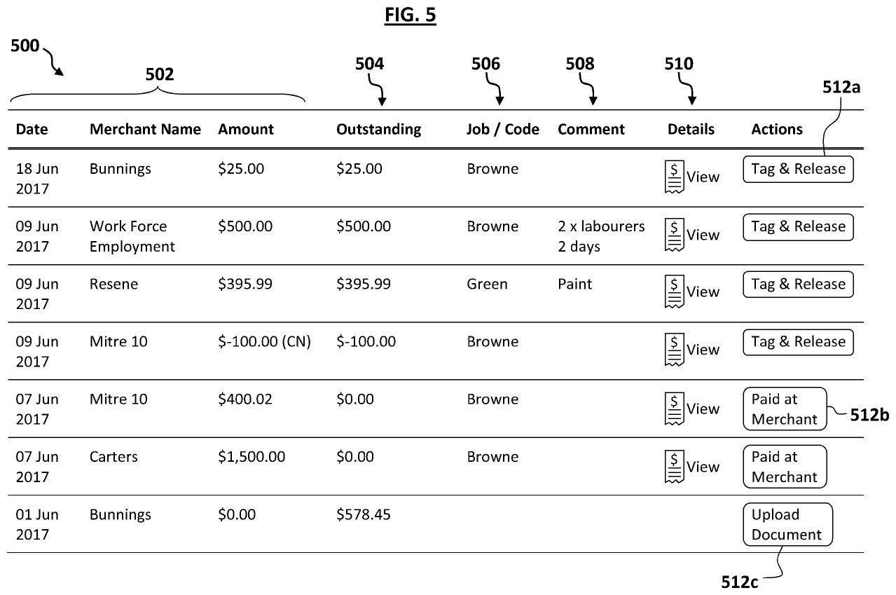

FIG. 5 illustrates a transaction processing user interface (UI) 500 displaying transactions received for a user-defined time period. Each transaction line includes merchant transaction data 502 in the form of the date of issuance, the merchant name, and transaction total amount. An outstanding column 504 indicates the amount awaiting payment, while Job/Code column 506 is populated with the user supplied transaction identifier and the Comment column 508 is populated with the purchase justification. An Invoice/Receipt viewing option 510 is selectable to display a reproduction of an associated invoice or receipt populated with data from the received transaction data packet. Status indicators 512 are provided for each transaction, for example: awaiting review and release for payment 512a, paid at merchant 512b, and document not yet received 512c (selection of which may allow manual uploading of data and information relating to the transaction).

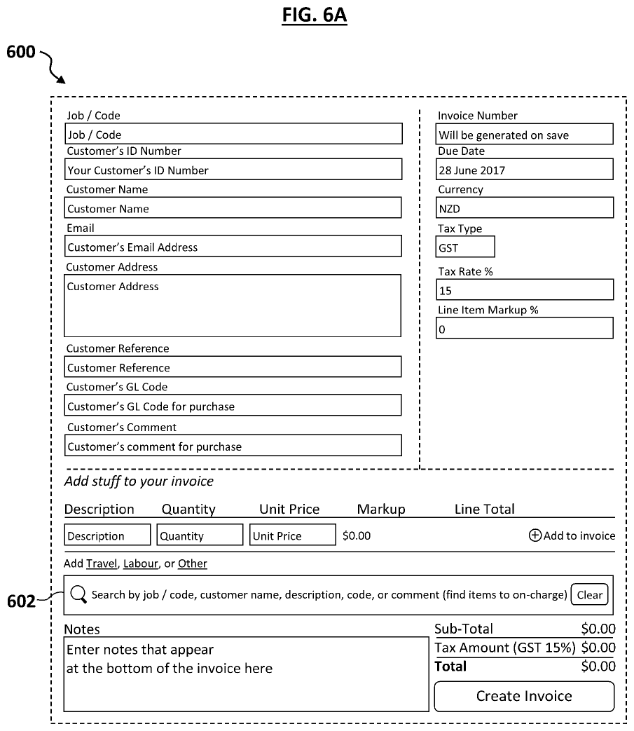

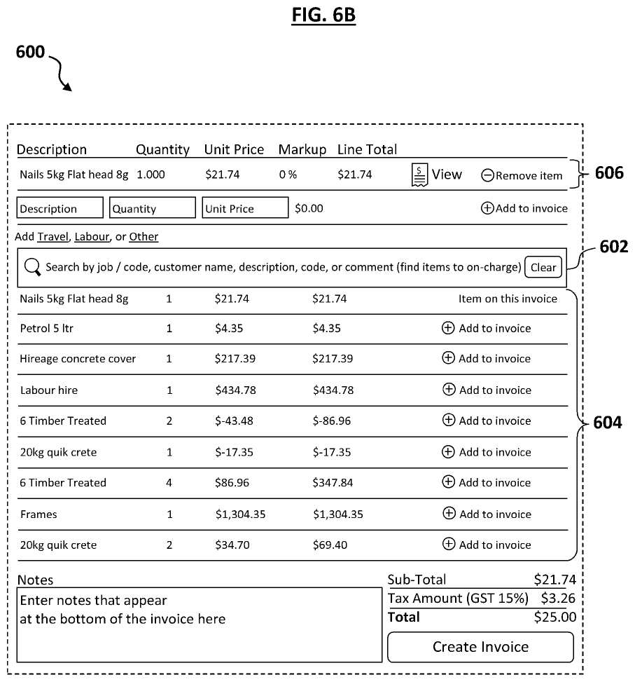

FIG. 6A and FIG. 6B illustrate a customer invoice generation user interface (UI) 600 accessible through the transaction processing service 102. In addition to a range of fields which may be populated by the user, or based on a template or previous invoice for a customer, the customer invoice generation UI 600 includes a search field 602 enabling searching for transactions, or line items within transactions, to be added to the invoice.

By way of example, in FIG. 6B the job designation “Browne” has been searched, and a drop-down menu 604 displayed containing each line item associated with that job based on the user supplied transaction identifier. On selection by the user, a line item is transferred to an included section 606 to form part of a customer invoice when issued.

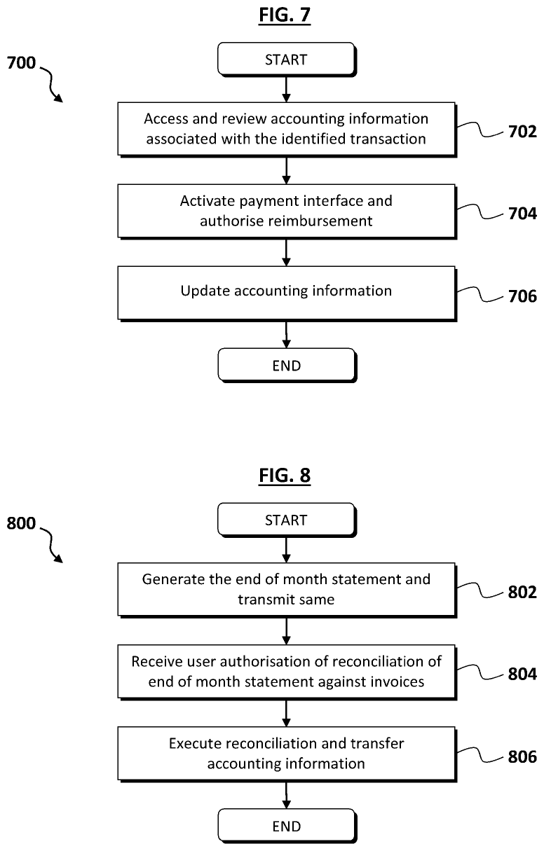

FIG. 7 illustrates an exemplary method 700 for expense reimbursement, for example of a transaction in which an employee has personally incurred a business expense. In step 702 accounting information associated with the transaction is accessed and reviewed via the transaction processing service 102. In step 704 the reviewing party activates a payment interface within the transaction processing service 102, and authorises reimbursement of the expense. In step 706 the associated accounting information is updated, both within the system 102 and on communication with the accounting service 122.

A similar process may be implemented for approval of payment of purchases made on account.

FIG. 8 illustrates an exemplary method 800 for invoice reconciliation against a merchant's end of month statement. In step 802 the merchant computing system 114a generates the end of month statement and transmits it to the transaction processing service 102. In step 804, the transaction processing service 102 receives user initiated authorisation to reconcile received invoice data against the received end of month statement, and in step 806 executes the reconciliation using at least the user supplied transaction identifier, and on completion transfers the updated accounting information to the accounting service 122.

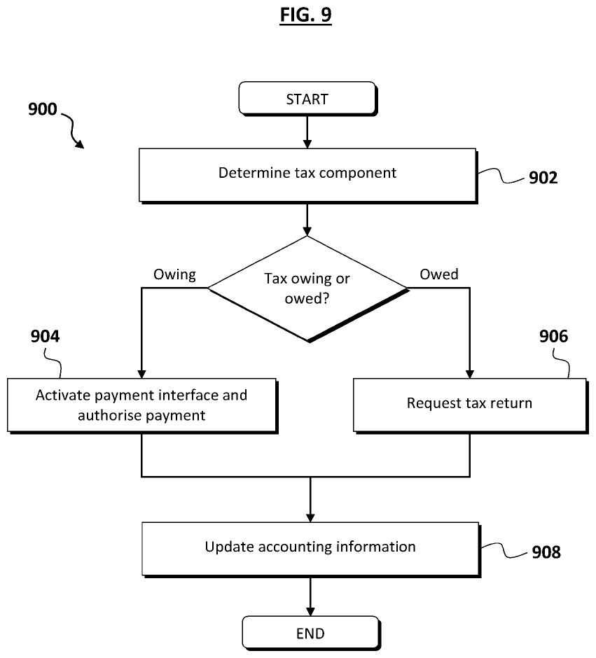

FIG. 9 illustrates an exemplary method 900 for processing tax associated with the transactions. In a first step 902 the transaction processing service 102 determines a tax component associated with a transaction recorded with the transaction processing computing system. The tax component may be that owing to a government, or one which may be claimed. By way of example, a Goods and Services Tax (GST) component of transactions received from merchants may be identified. The eligibility of this GST to be claimed may be determined, at least in part, using the user supplied transaction identifier. Similarly, invoices issued via the transaction processing service 102 may include a GST component, and the system may identify this as being owing. As a further example, the user supplied transaction identifier may be used to determine whether a transaction requires payment of Fringe Benefit Tax (FBT).

Where tax is owning, the transaction processing service 102 may activate a payment interface via which a user may authorise payment in step 904. Alternatively, where there is eligibility for a tax return, the transaction processing service 102 may populate the requisite form(s) and submit same to the tax agency services 124. In step 908, the associated accounting information is updated and recorded.

The invention(s) may also be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the disclosure and without diminishing its attendant advantages. It is therefore intended that such changes and modifications be included within the present disclosure.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor. A general-purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers, whether cloud based or dedicated, and network connections as known in the art.

In various embodiments, one or more cloud computing environments may be used to create, and/or deploy, and/or operate at least part of the software system that can be any form of cloud computing environment, for example: a public cloud, a private cloud, a virtual private network (VPN), a subnet, a Virtual Private Cloud (VPC), or any other cloud-based infrastructure known in the art. It should be appreciated that a service may utilize, and interface with, multiple cloud computing environments.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

Reference throughout this specification to “one embodiment” or “an embodiment” (or the like) means that a particular feature, structure, or characteristic described in connection with the embodiment is included in at least one embodiment of the disclosure. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the disclosure will be best understood by reference to the figures. The foregoing description is intended only by way of example and simply illustrates certain selected exemplary embodiments of the disclosure. It should be noted that the flowchart and block diagrams in the figures illustrate the architecture, functionality, and operation of possible implementations of systems, apparatuses, methods and computer program products according to various embodiments of the disclosure. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A system including:
a merchant computing system including: at least one processor; and a computer readable storage medium having computer readable program code embodied therewith and executable by the at least one processor, the computer readable program code including:
computer readable program code that produces a transaction data packet containing transaction data relating to the purchase of goods or services, wherein the merchant computing system is configured to receive a purchasing entity identifier and user supplied transaction identifier for inclusion in the transaction data packet;
a transaction processing computing system including: at least one processor; and a computer readable storage medium having computer readable program code embodied therewith and executable by the at least one processor, the computer readable program code including:
computer readable program code that receives the transaction data packet from the merchant computing system.

2. The system of claim 1, wherein the merchant computing system includes a point of sale device for interaction with a user's payment means to carry out the transaction, wherein the transaction data packet is distinct to communication between the merchant computing system and a financial institution to effect an electronic funds transfer authorised by a user via the point of sale device.

3. (canceled)

4. The system of claim 1, wherein the purchasing entity identifier is provided to the merchant computing system by one or more of: manual entry, scanning of an identification device, or via the device by which payment is effected.

5. The system of claim 1, wherein the merchant computing system is configured to receive a purchase justification for entry with the transaction information.

6. The system of claim 5, wherein the transaction includes a plurality of line items, and a purchase justification is provided for at least one of: each line item, one or more subsets of line items, and an entire set of line items.

7. The system of claim 1, wherein the transaction includes a plurality of line items, and a user supplied transaction identifier is provided for at least one of: each line item, one or more subsets of line items, and an entire set of line items.

8. The system of claim 1, wherein the transaction processing computing system includes computer readable program code that provides a user interface by which a user is enabled to access and review accounting information associated with received transaction data packet, and gain access to actions provided by the transaction processing computing system.

9. The system of claim 1, wherein the transaction processing computing system includes computer readable program code that provides a payment interface, for one or more of: payment of invoices, expense reimbursement, and payment of tax.

10. The system of claim 1, wherein the transaction processing computing system includes computer readable program code that identifies a transaction associated with a transaction data packet as being eligible for reimbursement to an individual based at least in part on the user supplied transaction identifier.

11. The system of claim 10, wherein the transaction processing computing system includes computer readable program code that automatically populates a payment interface for reimbursement based in part on the purchasing entity identifier.

12. The system of claim 1, wherein the transaction processing computing system includes:
computer readable program code that identifies a transaction relating to a purchase on account which has yet to be paid;
computer readable program code that facilitates review of accounting information relating to the transaction, and
computer readable program code that facilitates payment of the purchase on account.

13. The system of claim 1, wherein the transaction processing computing system includes:
computer readable program code that receives a merchant's end of month statement;
computer readable program code that reconciles invoices from received transaction data packets with the received end of month statement.

14. The system of claim 13, wherein the transaction processing computing system includes computer readable program code that identifies discrepancies between the statement and information associated with the individual invoices.

15. The system of claim 1, wherein the transaction processing computing system includes computer readable program code that determines a tax component associated with at least one transaction recorded with the transaction processing computing system.

16. The system of claim 15, wherein the transaction processing computing system includes computer readable program code that communicates with a taxation agency system to complete an action associated with the determined tax component.

17. (canceled)

18. (canceled)

19. The system of claim 1, wherein the transaction processing computing system includes computer readable program code that produces a customer consolidated invoice, including transaction data from a plurality of transactions relating to a customer.

20. (canceled)

21. The system of claim 1, wherein the transaction processing computing system includes computer readable program code that produces a merchant consolidated invoice, including transaction data from a plurality of transactions from related merchants.

22. (canceled)

23. The system of claim 1, wherein the transaction processing computing system includes computer readable program code that compares data associated with received transaction data packets against at least one purchase order issued to the one or more merchants from which the transaction data packets are received.

24. The system of claim 23, wherein the transaction processing computing system includes computer readable program code that issues the at least one purchase order, including at least one user supplied transaction identifier, and optionally at least one purchase justification.

25. A method, the method including: utilizing at least one processor to execute computer code that performs the steps of:
producing, at a merchant computing system, a transaction data packet containing transaction data relating to the purchase of goods or services, wherein the transaction data packet includes a purchasing entity identifier and user supplied transaction identifier received by the merchant computing system;
transmitting the transaction data packet to a transaction processing computing system.

26.-47. (canceled)
